(19) United States
(12) Patent Application Publication
(10) Pub. No.: US 2011/0199058 A1
(43) Pub. Date: Aug. 18, 2011

(54) AGM BATTERY RECOVERY AND CAPACITY TESTER

(75) Inventors: Paul J. Shoytush, Victor, NY (US); Michael Joseph Farman, Livonia, NY (US)

(73) Assignee: GM GLOBAL TECHNOLOGY OPERATIONS, INC., DETROIT, MI (US)

(21) Appl. No.: 12/708,477

(22) Filed: Feb. 18, 2010

(51) Int. Cl. H02J 7/04

(52) U.S. Cl. 320/162

(57) ABSTRACT

A system for battery recovery and capacity testing, including a battery charger for charging a battery, a load test resistor and a control relay. The system also includes an electronic controller connected to the battery, load test resistor and the control relay, and further in communication with the battery charger, where the electronic controller controls the battery charger so as to allow the battery to be charged, and also allow the battery to be load tested. The electronic controller calculates the capacity of the battery in ampere-hours at the end of the load testing.

The U.S. Government may have a paid-up license in this invention and the right in limited circumstances to require the patent owner to license others on reasonable terms as provided for by the terms under project FS&S support of Fuel Cell Vehicles at Ft. Belvoir, awarded by the U.S. Army.

### BACKGROUND OF THE INVENTION

1. Field of the Invention

This invention relates generally to a system and method for absorbent glass mat (AGM) battery recovery and capacity testing and, more particularly, to a system and method for recovering the capacity of an AGM battery and load testing an AGM battery to determine the capacity of the battery in ampere-hours.

2. Discussion of the Related Art

Valve regulated lead acid (VRLA) batteries are low maintenance, lead-acid batteries. VRLA batteries are also called recombinant batteries, and are commonly further classified as absorbent glass mat (AGM) batteries and gel batteries. In addition, because VRLA batteries use much less electrolyte (battery acid) than traditional lead-acid batteries, they are also occasionally referred to as an acid-starved design.

VRLA batteries can be mounted in any position, and are designed to be recombinant to eliminate emission of gases during overcharge, thereby reducing room ventilation requirements. Furthermore, little or no acid fumes are emitted during the normal operation of VRLA batteries. In the event of damage to a VRLA battery, the volume of free electrolyte that could be released is quite small. Finally, there is no need, or possibility, to check the level of electrolyte or to add water that is lost due to electrolysis. Thus, VRLA batteries are safer, more versatile, environmentally friendly, and require less maintenance to function as desired.

Absorbent glass mat (AGM) batteries are a class of VRLA battery in which the electrolyte is absorbed into a mat of fine glass fibers. AGM batteries are capable of providing more current and for a longer period of time compared to a standard lead-acid battery, making them an attractive option for a wide variety of applications, including vehicle applications. The plates in an AGM battery may be flat, such as in AGM batteries in a rectangular case, or may be thin and wound, as in cylindrical AGM batteries.

Generally, battery state of charge (SOC) is measured by various battery testing equipment to determine the health of a battery. Typically, SOC cannot be determined directly, thus, various methods including chemical, voltage, current integration, and pressure methods are used to indirectly measure SOC. However, testing SOC does not give an accurate measure of the health of a battery. The typical way to test capacity is with a constant current sink. However, a constant current sink is expensive and requires set-up and hand calculations. Furthermore, AGM batteries generate a significant amount of heat when a large amount of current is applied, even for a short period of time, introducing the potential for error during battery testing. Therefore, AGM batteries must be tested using a small amount of current for a long period of time to ensure the testing results are accurate. In addition, when AGM batteries are left discharged for a period of time, such as a couple of days, the AGM batteries may lose capacity.

Thus, there is a need in the art for an inexpensive test that measures ampere-hours to determine the health of a battery, and there is also a need in the art for a recovery procedure for AGM batteries that have been left discharged for a period of time, such as a couple of days, to recovery the AGM battery capacity. Furthermore, due to the length of time necessary to load test an AGM battery, and the length of time to recover capacity of an AGM battery, there is a need in the art for an automated testing solution.

### SUMMARY OF THE INVENTION

In accordance with the teachings of the present invention, a system for battery recovery and capacity testing is disclosed. The system includes a battery charger for charging a battery, a load test resistor and a control relay. The system further includes an electronic controller connected to the battery, load test resistor and the control relay, and further in communication with the battery charger, where the electronic controller controls the battery charger so as to allow the battery to be charged, and also allows the battery to be load tested. The electronic controller calculates the capacity of the battery in ampere-hours at the end of the load testing.

Additional features of the present invention will become apparent from the following description and appended claims, taken in conjunction with the accompanying drawings.

### BRIEF DESCRIPTION OF THE DRAWINGS

FIG. 1 is a schematic block diagram of an AGM battery recovery and capacity testing system;

FIG. 2 is a typical current decay curve of an AGM battery; and

FIG. 3 is a polynomial approximation of a typical current decay curve of an AGM battery.

### DETAILED DESCRIPTION OF THE EMBODIMENTS

The following discussion of the embodiments of the invention directed to a system and method for an AGM battery recovery and capacity testing system is merely exemplary in nature, and is in no way intended to limit the invention or its applications or uses.

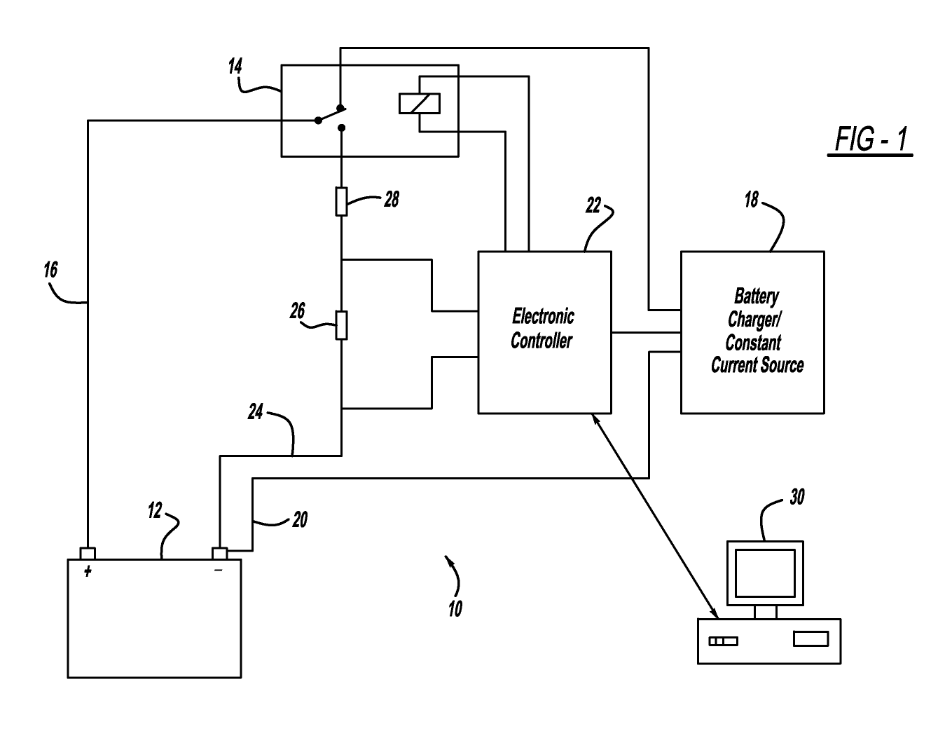

FIG. 1 is a schematic block diagram of an AGM battery recovery and capacity testing system 10 including an AGM battery 12. The AGM battery 12 is connected to a control relay 14 by a positive lead 16. The AGM battery 12 is also connected to a battery charger 18 by a first negative lead 20, and is also connected to an electronic controller 22 and the control relay 14 by a second negative lead 24. A load test resistor 26 is connected to the second lead 24, and an optional resistor 28 may also be connected to the second lead 24. The electronic controller 22 controls the battery charger 18 and also communicates with a display or computer 30. The method for utilizing the system 10 to automatically test the capacity of the AGM battery 12 is discussed in more detail below.

First, the battery charger 18 will charge the AGM battery 12 to 100% state of charge (SOC). Once the battery SOC reaches 100%, the battery charger 18 ceases to charge the battery 12. The battery 12 is then allowed to sit for approximately six hours to remove any surface charge. Next, an open circuit voltage of the battery 12 is determined. The open circuit voltage should be 12.8 volts or higher to continue testing. If the open circuit voltage of the battery 12 is not 12.8 volts or higher, the battery 12 will probably not pass the load test, and replacement of the battery 12 may be required. The display or computer 30 or the electronic controller 22 of the system 10 may also include a display that can display the state and condition of the battery 12, as well as the test progress. In addition, the system 10 may have a selectable voltage switch (not shown) for the test ending conditions, and may have a selectable current setting so that the AGM battery 12 may be tested at various currents.

After it has been determined that the open circuit voltage of the battery 12 is 12.8 volts or higher, the battery 12 is load tested with a 1 ohm (225 watt) resistor 26 for approximately 2.5 hours. Those having skill in the art will recognize that variations in the resistor 26 and length of time of the test are possible without departing from the scope of the present invention. Because the current is being pulled across the load resistor 26, the current decays over time. If, after 2.5 hours of load testing, and while still under load, the voltage of the battery 12 is 11.0 volts or less, then the capacity of the battery 12 is determined to be at or below 80% of its rated capacity, and replacement may be recommended. Similarly, if the battery 12 has a voltage of 11.0 volts after 2.75 hours of load testing, then the capacity of the battery 12 is determined to be 90%. The capacity of the battery 12 is determined to be 100% if, after 3 hours of load testing, the battery 12 is at 11.0 volts. How the percentage of capacity is determined is described in more detail below.

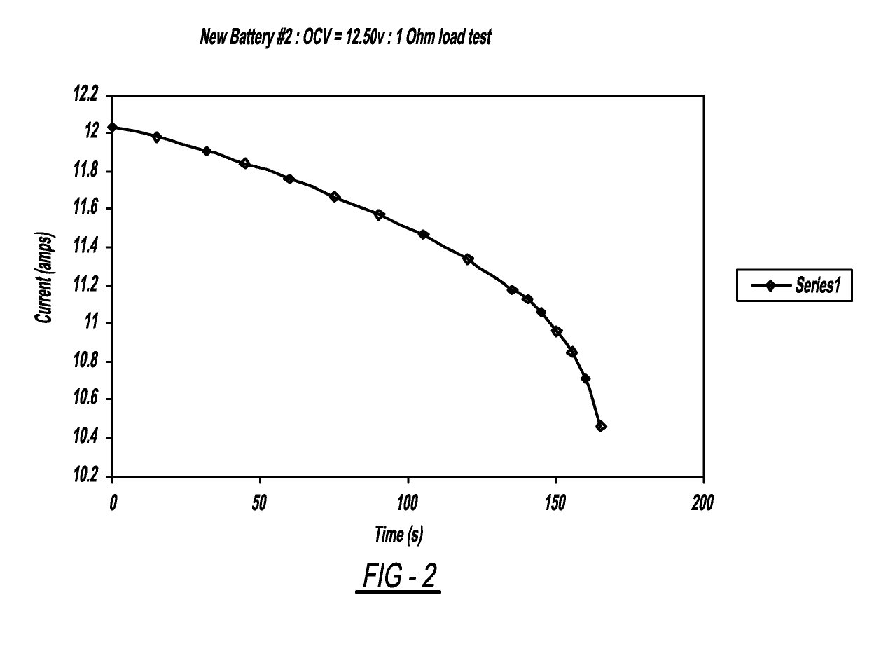

FIG. 2 is a typical current decay curve of the AGM battery 12, with time on the x-axis and current (amps) on the y-axis illustrating that current decays during the length of the test of the system 10. Voltage is measured and recorded periodically during the course of the test. An example time frame for measuring and recording voltage is measuring voltage at fifteen minute intervals. However, those having skill in the art will recognize that a wide range of time intervals may be used. The measurements are plotted on a graph with time on the x-axis and current (amps) on the y-axis, thus generating a current decay curve for the AGM battery 12 tested by the system 10. Once the current decay curve is generated, the ampere-hour capacity of the AGM battery 12 is determined by integrating to determine the area under the current decay curve. The approximation of the area under the current decay curve is described in more detail below.

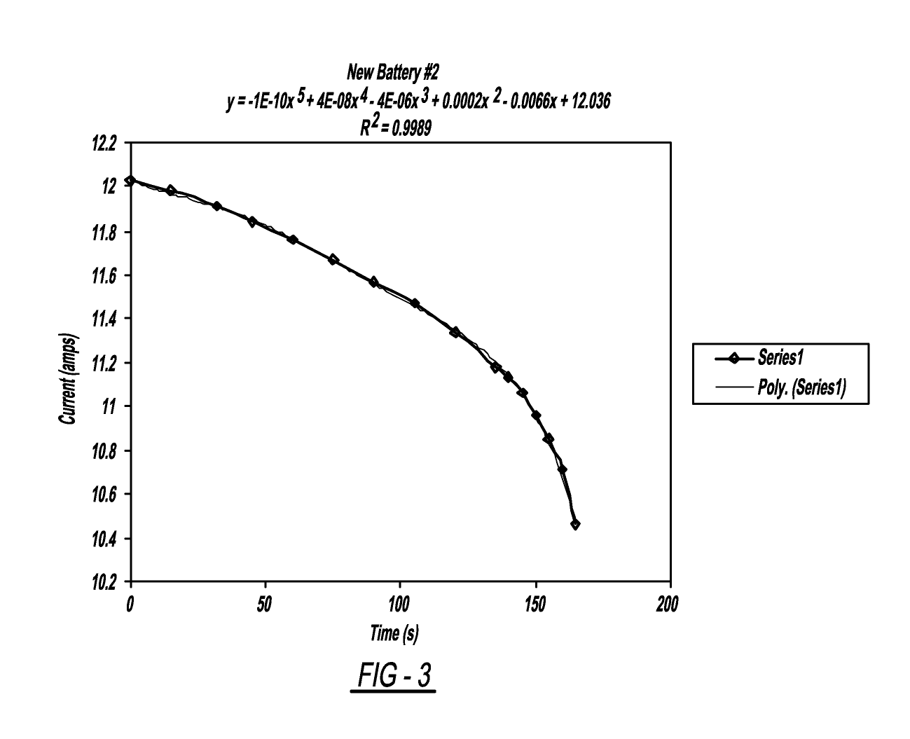

FIG. 3 is a current decay curve with time on the x-axis and current (amps) on the y-axis including a curve approximation utilizing a 5^{th} order polynomial according to the following equation:

y=−1E−10x⁵+4E−08x⁴−4E−06x³+20.0002x²−0.0066x+12.036

R²=0.9989

However, utilizing a 5^{th} order polynomial is merely exemplary and one skilled in the art will recognize there are various methods for approximating the area under a current decay curve. Once the area under the current decay curve is approximated, the ampere-hour capacity of the AGM battery 12 is determined based on the calculated area under the current decay curve.

Another application for the AGM battery recovery and capacity testing system 10 is to “recover,” or increase the capacity of a discharged AGM battery to, or near, full capacity. Recovery of an AGM battery may be utilized when the AGM battery has been left discharged for a period of time, such as a couple of days. To recover a discharged AGM battery, the battery charger 18 includes a constant current source capable of supplying a certain amperage and voltage, such as 2 amps and 36 volts. The recovery procedure, discussed in more detail below, charges the discharged AGM battery 12 at a constant current for a certain time, such as 2 amps for 24 hours, and then discharges the battery 12 to about 10 volts multiple times to recover the battery 12 to, or near, full capacity.

To recover the AGM battery 12 when it has been discharged, the first step is to bring the battery 12 to room temperature, or approximately 25° C. or 77° F. Next, the open circuit voltage (OCV) of the discharged battery 12 is measured by the electronic controller 22, and the measured OCV is stored in the memory of the electronic controller 22.

Once the measured OCV is determined and saved, the AGM battery 12 is charged by the battery charger 18 at a constant current, for example, 2 amps for about 24 hours. The battery charger 18 should be capable of providing a driving voltage as high as 36 volts. As will be readily apparent to those skilled in the art, the amps, voltage and/or length of time for charging the AGM battery may be varied without departing from the scope of the present invention.

After the AGM battery 12 has been charged, the battery 12 is left to stay at open circuit for at least 2 hours. The AGM battery 12 is then connected to a vehicle and is discharged by turning on lights and/or various other accessories that are on the vehicle. One having skill in the art will readily recognize that the battery 12 may be connected to a variety of vehicular and non-vehicular discharging sources to allow discharge of the battery 12 without departing from the scope of the present invention. If the AGM battery 12 is connected to a vehicle, it is important to keep the hood open on the vehicle. If the vehicle also includes a fuel cell system, the fuel cell system should not be started while the battery 12 is being discharged. The AGM battery 12 is discharged until the battery 12 reaches about 9.0 to 10.0 volts. The length of time of discharge until the battery 12 reaches the desired voltage is recorded by the electronic controller 22.

Next, the AGM battery 12 is disconnected from the vehicle and is again charged using the battery charger 18. After the AGM battery 12 is charged, the battery is again allowed to sit for at least 2 hours on an open circuit. After sitting for at least 2 hours, the AGM battery 12 is again connected to a discharging source, such as a vehicle, to discharge the battery. Again, the AGM battery 12 is discharged until it reaches about 9.0 to 10.0 volts. The amount of time required to discharge the battery 12 to the desired voltage is again recorded.

The AGM battery 12 is charged and discharged as described above at least three times. The discharge time should increase during every cycle, which indicates that the battery 12 has a good charge capacity. If the battery 12 does not hold the charge, i.e., if the discharge time is not increasing, the battery 12 may need to be discarded. If the amount of discharge time is increasing as expected, the battery may be labeled appropriately and stored for future use.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A system for battery capacity testing, said system comprising:
a battery charger for charging a battery;
a load test resistor;
a control relay coupled to the battery, the load test resistor and the battery charger; and
an electronic controller coupled to the battery, load test resistor and the control relay and further in communication with the battery charger, said electronic controller controlling the battery charger so as to allow the battery to be charged, wherein the electronic controller allows the battery to be load tested and calculates the capacity of the battery in ampere-hours at the end of the load testing.

2. The system according to claim 1, further comprising a first lead attached to a first terminal of the battery, a second lead attached to a second terminal of the battery, and a third lead also attached to the second terminal of the battery, wherein the first lead couples the battery to the control relay, the second lead couples the battery to the electronic controller and the load test resistor, and the third lead couples the battery to the battery charger.

3. The system according to claim 1, wherein the battery is an AGM battery.

4. The system according to claim 1, further comprising a selectable voltage switch so as to enable the end condition at the end of the load testing to be any voltage desired.

5. The system according to claim 1, further comprising a selectable current setting so as to allow the battery to be tested at different currents.

6. The system according to claim 1, wherein the battery is charged to approximately 100% state of charge.

7. The system according to claim 1 wherein a load is applied to the battery to remove any surface charge.

8. The system according to claim 1, wherein the battery is load tested with the load test resistor having a selected ohmic resistance until the selected end voltage is achieved.

9. A system for battery capacity testing, said system comprising:
a battery charger for charging a battery;
a load test resistor;
a control relay coupled to the battery, the load test resistor, and the battery charger;
an electronic controller coupled to the battery, load test resistor and the control relay, and further in communication with the battery charger, said electronic controller controlling the battery charger so as to charge the battery to approximately 100% state of charge, and controlling a load applied to the battery to remove any surface charge and determining the open circuit voltage of the battery to allow the battery to be load tested with the load test resistor until the selected end voltage is achieved if the voltage of the battery is determined to be at an acceptable level, and wherein the capacity of the battery is calculated in ampere-hours at the end of the load testing by determining the area under the current decay curve by measuring voltage periodically during load testing; and
a display which displays the state of charge and condition of the battery before testing, during testing and after testing, and further displays the progress of the test.

10. The system according to claim 9, further comprising a first lead attached to a first terminal of the battery, a second lead attached to a second terminal of the battery, and a third lead also attached to the second terminal of the battery, wherein the first lead couples the battery to the control relay, the second lead couples the battery to the electronic controller and the load test resistor, and the third lead couples the battery to the battery charger.

11. The system according to claim 9 wherein determining the area under the current decay curve includes approximating the area under the current decay curve.

12. The system according to claim 11 wherein the area under the current decay curve is approximated using a 5^{th} order polynomial equation.

13. The system according to claim 9, further comprising a selectable voltage switch so as to enable the test ending condition to be any voltage desired.

14. The system according to claim 9, further comprising a selectable current setting so as to allow the battery to be tested at different currents.

15. The system according to claim 9, wherein the battery is an AGM battery.

16. A system for increasing the capacity of a discharged battery, said system comprising:
a battery charger for charging a battery, said battery charger including a constant current source;
a load test resistor;
a control relay coupled to the battery, the load test resistor and the battery charger; and
an electronic controller coupled to the battery and the battery charger, wherein the controller measures the open circuit voltage of the battery, which is stored in a memory of the controller, and wherein the battery charger charges the battery at a constant current using the constant current source and the battery is then discharged after it is left at open circuit for a desired period of time, where the time elapsed during discharge is measured by the controller and stored in the memory of the controller.

17. The system according to claim 16 wherein the constant current used to charge the battery is about 2 amps for about 24 hours.

18. The system according to claim 16 wherein the controller charges and discharges the battery several times to bring the battery up to, or near, full capacity.

19. The system according to claim 18 wherein the controller records the amount of time required for discharging the battery each time the battery is discharged, and determines whether the battery should be discarded by comparing the discharge times.

20. The system according to claim 16 wherein the battery is discharged to about 9.0 to 10.0 volts.
